(19) United States
(12) Patent Application Publication
(10) Pub. No.: US 2014/0208970 A1
(43) Pub. Date: Jul. 31, 2014

(54) MACHINE AND METHOD FOR PRINTING MATERIAL WEBS

(71) Applicant: Bjoern Weidmann, Osnabrueck (DE)

(72) Inventor: Bjoern Weidmann, Osnabrueck (DE)

(73) Assignee: WINDMOELLER & HOELSCHER KG, Lengerich (DE)

(21) Appl. No.: 14/238,530

(22) PCT Filed: Aug. 17, 2012
(86) PCT No.: PCT/EP2012/066084

§ 371 Date: Feb. 12, 2014

(30) Foreign Application Priority Data
Aug. 22, 2011 (DE) 10 2011 110 796.0

(51) Int. Cl. B41J 11/00

(52) U.S. Cl. CPC B41J 11/0095
USPC 101/417

(57) ABSTRACT

The invention describes a machine for printing material webs (4),
which comprised a station (1, 11, 41) for monitoring the printed material web (4),
with the station (1, 11, 41) for monitoring the material web (4) comprising a sensor for monitoring the material web (4) and at least one counter support (2, 12) for guiding the web (4), with at least one counter support (2, 12) being located on the side of the web facing away from the sensor (3, 13),
and with the surface of the counter support facing the material web at least partially being made from a porous or perforated material.

It is characterized in a surface of the counter support facing the material web (4), showing a reflector (34) and/or a background illumination (39).

The invention relates to a machine and a method for printing material webs. Printed materials are examined in order to control the printing results. Generally, for this purpose a finished printed product is removed and examined for its optic impression, among other things. Recently, printed material webs are increasingly observed inline via sensors, such as cameras, in order to monitor the result of the printing process and to faster come to a conclusion. DE 10 2004 007 374 B3 also shows a device for the inline web monitoring. In this publication the web to be examined is guided by a counter support in the area of the web observation station. Here, the counter support is positioned on the side of the web facing away from the sensor. The counter support shows a porous or perforated surface, with air being pressed through it. As a consequence of this measure an air pocket forms, on which the web glides.

Experience has shown that measuring errors occur in the inline web observation stations shown above. This particularly applies when the measuring occurs by imaging sensors, in the following also called second sensors.

Therefore, the objective of the present invention is to reduce these measuring errors. The objective is attained in Claims 1 and 10. Accordingly, blowing air is used in order to generate an air pocket on which the web can float in an effective combination with porous or perforated material.

Micro-porous Teflon is recommended in particular as the porous material. This material can be produced in a sintering process, shows good emergency running features, and is even so stable that during the production of pipes made from this material any supporting structure can be foregone. The provision of an optically active element in the counter support makes it possible to make bright or even white image elements visible on a transparent subsurface. Surprisingly good results can be achieved with a reflector here. It is advantageous in an observation station to additionally provide a roller—preferably a white roller—which can assume the function of a counter support. The two elements, roller and counter support, can be made to contact the material web complementarily or alternatively. The illumination of the observation area of the sensor is also advantageous with additional illumination devices such as bright and dark field illumination.

In particular, when color values are measured inline, an air pocket between the counter support and the printed material is rather obstructive. Thus, for sensors intended to perform such measurements (in the following also called first sensors) it may be advantageous to press the material web against the counter support, for example using air flow.

An advantageous, alternative or complementary option to avoid such an air pocket comprises applying a vacuum to the side of the material web facing away from the sensor, and thus suctioning it towards the counter support. For this purpose, the counter support must be provided with appropriate suction apertures or the like. Suction or vacuum devices must also be provided. The disadvantages of a vacuum include that any misalignment of the web naturally leads to a complete opening of the vacuum jets to the environment, which may result in a rapid loss of vacuum. Furthermore, any change of the web format (change of the width of the web) makes an adjustment of the vacuum jets necessary as well (vacuum jets need to be closed for narrower webs and vice versa).

Both the use of a vacuum as well as the use of blow air leads to a compression of the web against the counter support. It is interesting that the web seems to initially show a certain resistance against the “compression,” which increases with the traveling speed of the web. This circumstance might be explained with the laminar air flow, which is entrained by the web when traveling. When this resistance has been overcome and the web falls short of a certain distance from the counter support, the Bernoulli effect applies between the web and the counter support and leads to a further approach of the web towards the counter support. It is possible and in many cases advantageous to reduce the distance to a range of one millimeter or even less (>0.5 mm, >0.2 mm, actually preferably >0.1 mm or >0.05 mm, etc.) or even to establish a complete contacting of the web.

The quality of the testing of the printed material is improved by the reduction of the distance between the web and the counter support. This particularly applies for measurements of the color location and the like. Such measurements are advantageously performed using spectral-photometrical measuring sensors.

In this context particularly a planar and/or white surface of the counter support shows advantages.

Due to the fact that friction may develop between the web and the counter support, it is advantageous for the area of the counter support, which may come into contact with the web, to extend only over a portion of the width of the web. In this case it is advantageous for the counter support to be displaceable in this direction. This may occur by the counter support being fastened moveably on a sled on a traverse.

It is advantageous to provide at least one second sensor in the immediate proximity of the first sensor and the first counter support. Using this at least one second sensor, other parameters may be measured than with the first sensor. This is very advantageous for the following reasons, and leads to a further improvement of the quality of measurements taken by at least one first sensor:

The first sensor may be triggered by a second sensor. This shows particular advantages when at least one first sensor is a spectral-photometric sensor and at least one second sensor is an imaging sensor. In addition to triggering, an orientation of the first sensor in a x-z level may then be given, for example. The short distance between the first and the second sensors reduces imprecisions, for example caused by an alternating web stretching. Thus it is advantageous when only one guide roller or none at all is located in the web path between the measuring points of at least one first and at least one second sensor.

Based on the other measuring parameters, which should be measured by at least one second sensor, the desired distance between the web and the second counter support may be completely different from the one between the web and the first counter support. Air pockets and rollers can once more be used advantageously here.

The individual figures show:

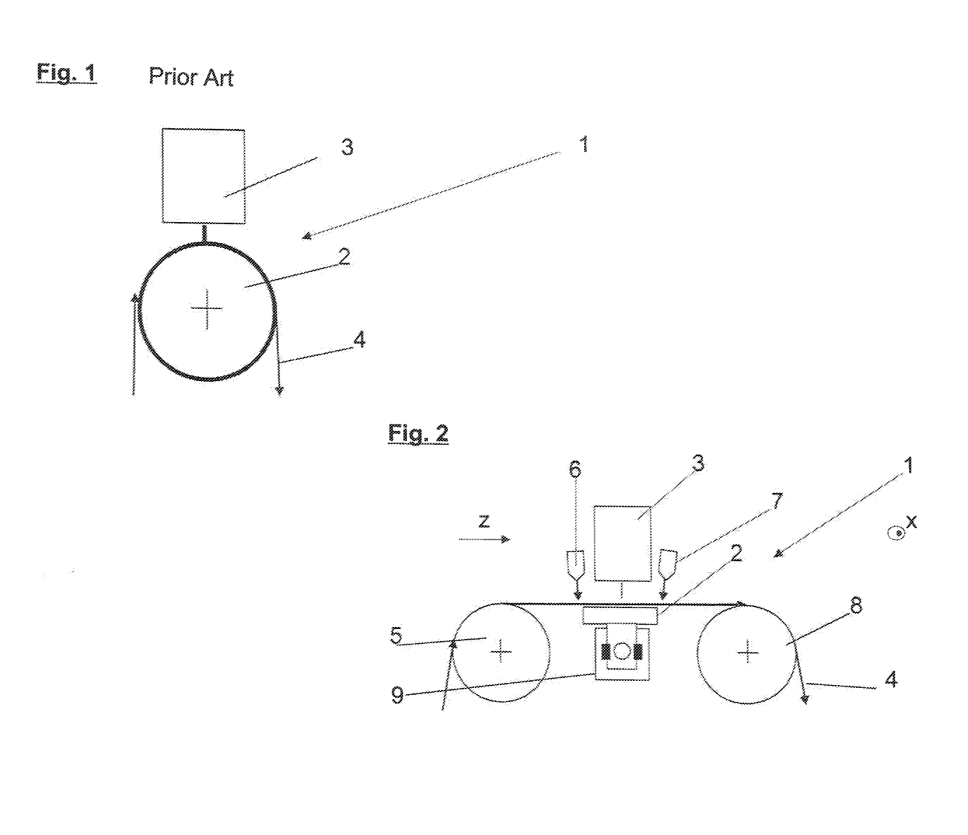

FIG. 1 A station for monitoring a material web according to prior art,

FIG. 2 A station with a first sensor and a first counter support,

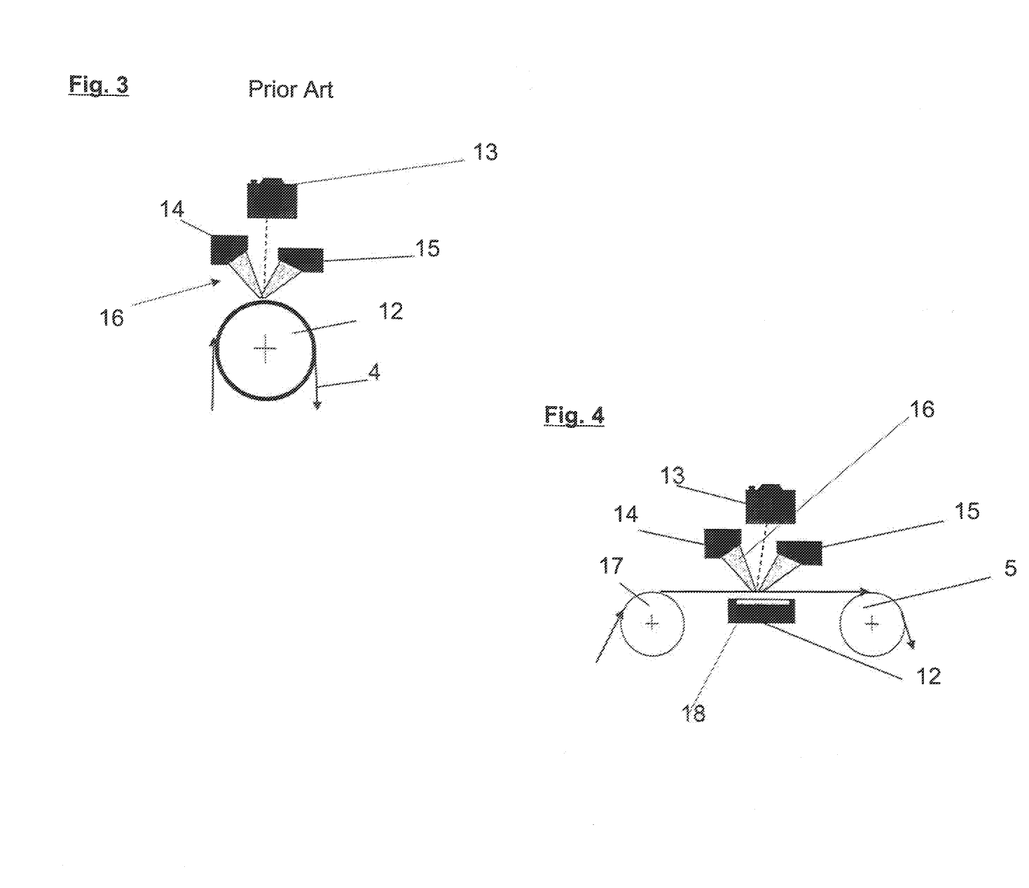

FIG. 3 A second station for monitoring a material web according to prior art,

FIG. 4 A station with a second sensor and a second counter support,

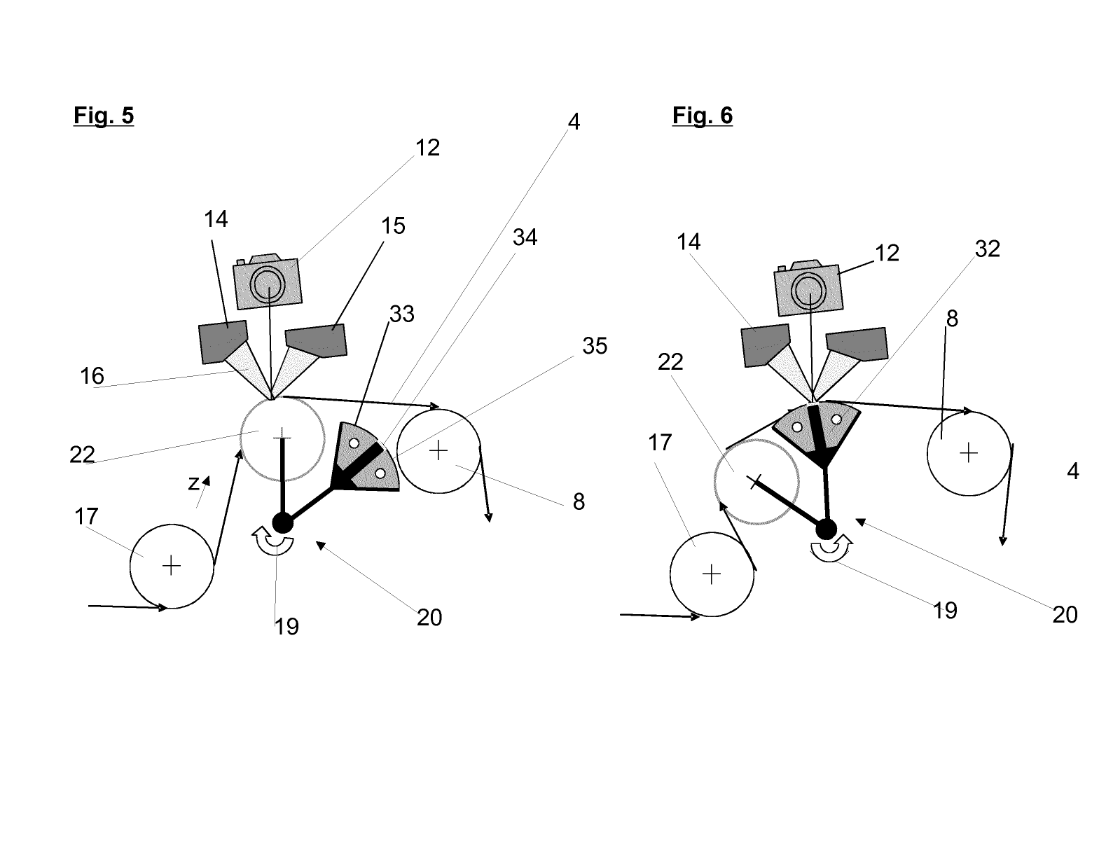

FIG. 5 Another station with a second sensor and a second counter support,

FIG. 6 The station from FIG. 5 in a different operating mode,

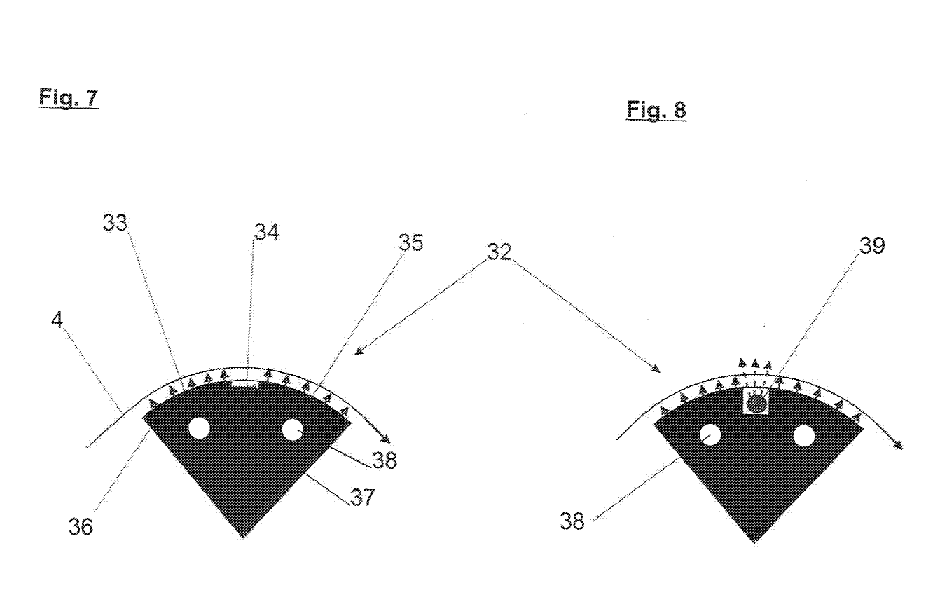

FIG. 7 A cross-sectional illustration of an advantageous second counter support,

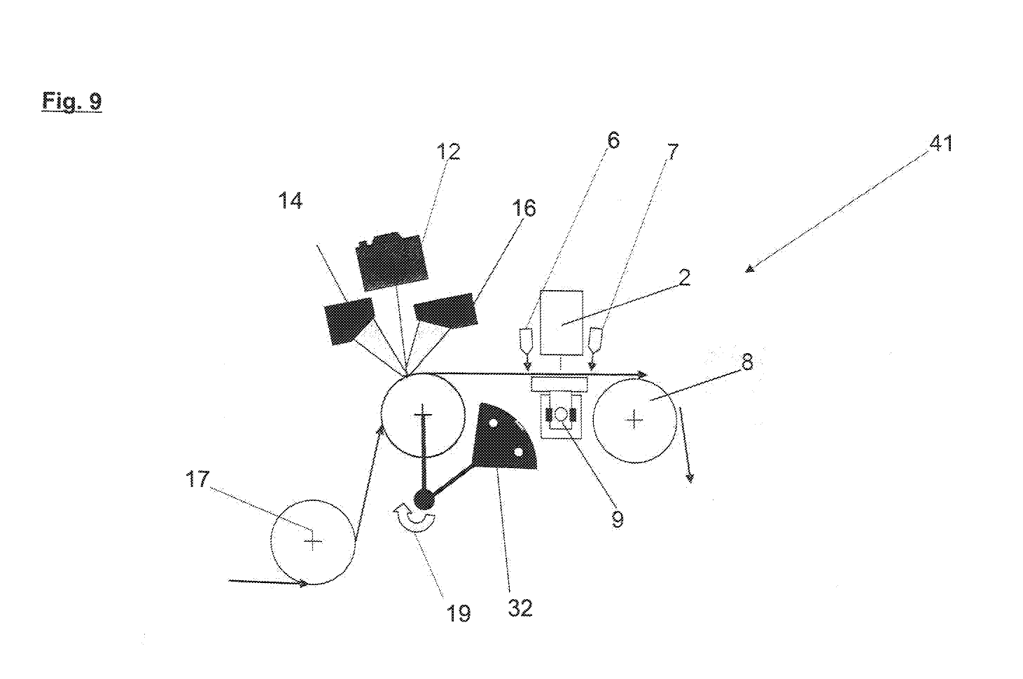

FIG. 8 A cross-sectional illustration of another advantageous second counter support,

FIG. 9 A station with a first and a second sensor and a first and a second counter support.

FIG. 1 shows a station 1 for monitoring a material web 4 according to prior art, in which a non-transparent web material travels on a black rubber roller 1, which serves as a first counter support 2, and is guided past a first sensor 3. In transparent web materials white rollers should actually be used. However, they are expensive, become soiled very easily, and thus they are not practical. FIG. 2 shows a station 1 for monitoring a material web 4 in a machine according to the invention. In this station 1 the web first travels over the master roller 5, provided with a rotary pulse generator, not shown, into the station 1. Subsequently, the web is influenced by the compressed air jet 6, which emits compressed air pressing the web 4 in the direction towards the counter support 2. In the proximity of this first counter support 2 the first sensor 3 performs its measurements. Another influencing area of a compressed air jet is located downstream in reference to the counter support 2, namely the compressed air jet 7. The web 4 leaves this station 1 via the guide roller 7. The counter support 2 may be embodied like tiles. It may be displaced with the help of a traverse 9 into the correct position in the x-direction of the web 4 (width). Additionally, the exchange of one tile is easy and cost-effective. An automatic test for soiling can also occur easily and quickly due to the small area in question, because the tile can be moved out of the proximity of the printed material 4 and measured there. This would not be possible with a roller.

When measuring transmissive and/or transparent materials, the air gap between the printed material and the measuring background is of decisive importance for the quality of measurements. Simultaneously, any permanent contact of the printed material with the background should be avoided.

For this reason, one solution provides that the measuring background 2 is located slightly below the printed material 4 guided by two rollers 5, 8. For the measurement, the material is blown via pressurized air jets 6, 7 against the measuring background 2. The jets are located in the travel direction z of the web shortly before and behind the measuring background. This way, the entrained air is scraped off at the edges of the measuring background and the air gap is reduced to a minimum. Based on the Bernoulli effect, the web is suctioned towards the background better and better with increasing traveling speed. The pressure of the compressed air can furthermore be adjusted to the material features, web tension, and web speed. After the measuring process has been concluded, the compressed air is shut off so that the web 4 once more moves freely.

The web 4 could also be suctioned to the measuring background 2 by a vacuum. This solution however leads to problems when measuring near the edge of the web, because here only insufficient vacuum can form for suctioning the web 4. When using compressed air this is irrelevant.

FIG. 3 shows a simple second station 11 for monitoring a material web, which is partially used in prior art for imaging sensors 13. The web progression is the same as in FIG. 1. Here, a white roller 12 is used as the measuring roller (with the requirements not being as high as during color measurements). The disadvantages of such a method include that white objects cannot be detected on transparent materials. Here, the bright field 14 and the dark field 15 illumination are to be mentioned, with their light cones 16 also being shown. FIG. 4 shows a second station 11, in which the guiding of the web 4 is performed by the guide roller 17 and the master roller 5. The counter support 12, or rather the measuring background, does not contact the web 4. However, this counter support is equipped with a background illumination 18 such that the camera 13 also can detect the “white eagle on white background” here.

FIGS. 5 and 6 show another second station 11 for monitoring a material web 4. This station comprises a counter support system 20 with alternative counter supports 22 and 32, in FIG. 5 one white roller 22 serves as the counter support and/or measuring background. The arrow 19 indicates that the system 20 can also activate the counter support 32 within the scope of a pivotal motion, as shown in FIG. 6. Here, the roller 22 only serves as a guide roller, while the counter support 32 guides the web on the side opposite the sensor.

FIGS. 7 and 8 show two exemplary embodiments for this counter support 32. The surface of the counter support 32 facing the web 4 shows a convex profile. In the travel direction z of the web, the web 4 first travels over the first surface 33 of the counter support 32. It is made from a porous material, preferably micro-porous Teflon, which can be produced by a sintering process. This material is penetrated by a pipe 38, which introduces compressed air. This compressed air flows through the porous material and exits, as shown by the arrows 36, at the first surface 33 of the porous material.

Here, an air pocket forms, which is illustrated by the arrows 36, and floats above the web 4. Then, traveling in the direction of transportation z, the web reaches the proximity of the reflector 34, which may replace a background illumination 18, 39. The measure of using a reflector 34 as the measuring background has proven so advantageous that this measure is beneficial, even independent from the remaining design of the measuring station, and perhaps deserves patent protection.

In the direction of transportation z of the web, a second surface 35 of the counter support 32 is arranged downstream in reference to the reflector 34, designed as a mirror-image of the first surface 33 of the counter support 32. The counter support 32 shows a pressure-resistant housing 37 on the sides facing away from the web 4, preventing any escape of compressed air. The counter support 32 in FIG. 8 shows, instead of the reflector 34, a background illumination 39 and is otherwise designed identical to the counter support 32 shown in FIG. 7. FIG. 9 shows a station 41, which combines the functional components of the station 11 of FIG. 5 with the functional components of station 1 of FIG. 2.

As already mentioned, this arrangement in one station provides additional advantages for the quality of the measurement, in case of multi-color printing machines it is advantageous to provide one of the stations 1, 11, 41 shown downstream in reference to the last printing device. The use of compressed air jets 6, 7 also leads to a cleaning of the web 4 and the optic elements of the web monitoring station.

List of reference characters

| | |
|---|---|
| 1 | First station for monitoring a material web |
| 2 | First counter support/measuring background |
| 3 | First sensor |
| 4 | Material web/web |
| 5 | Master roller |
| 6 | First compressed air jet |
| 7 | Second compressed air jet |
| 8 | Guide roller |
| 9 | Traverse |
| 10 | |
| 11 | Second station for monitoring a material web |
| 12 | Second counter support/measuring background |
| 13 | Second sensor |
| 14 | Bright field illumination |
| 15 | Dark field illumination |
| 16 | Light cone |
| 17 | Guide roller |
| 18 | Background illumination |
| 19 | Arrow in the pivotal direction of the counter supports 32 and 22 |
| 20 | Counter support system |
| 21 | |
| 22 | White roller |
| 23 | |
| 24 | |
| 30 | |
| 31 | |
| 32 | Counter support |
| 33 | First surface of the counter support 32 |
| 34 | Reflector |
| 35 | Second surface of the counter support 32 |
| 36 | Arrows (air outlet from the counter support 32) |
| 37 | Pressure-resistant housing of the counter support 32 |
| 38 | Channel/pipe for compressed air |
| 39 | Background illumination of the counter support 32 |
| 40 | |
| 41 | Station for monitoring a material web |
| 42 | |
| 43 | |

1. A machine for printing material webs (4),
which comprises a station (1, 11, 41) for monitoring the printed material web (4),
with the station (1, 11, 41) for monitoring the material web (4) comprising a sensor for
monitoring the material web (4) and at least one counter support (2, 12) for guiding the web (4), with at least one counter support (2, 12) being located on the side of the web facing away from the sensor (3, 13),
and with the surface of the counter support facing the material web at least partially being made from a porous or perforated material,
characterized in that
the surface of the counter support facing the material web (4) comprises a reflector (34) and/or a background illumination (39).

2. A machine according to claim 1,
characterized in that
the surface of the counter support (2, 12) facing the material web (4) is made at least partially from micro-porous Teflon.

3. A machine according to claim 1,
characterized in that
the station (1, 11, 41) is equipped, in addition to the counter support (2, 12), with a white roller (22), by which the material web (4) can be guided in the operating range of the sensor.

4. A machine according to claim 3,
characterized in that
the material web can be guided with the white roller (22) and the counter support (2, 12) alternatively in the operating range of the sensor(3, 13).

5. A machine according to claim 4,
characterized in that
the white roller (22) can be shut off by the material web (4).

6. A machine according to claim 1,
characterized in that
the counter support (3, 13) is stationary in reference to the material web (4).

7. A machine according to claim 6,
characterized in that
the surface of the stationary counter support (32) facing the material web (4) comprises, in the direction of the web travel (z) and/or downstream in reference to the optic element (34, 39), a porous or perforated material, preferably micro-porous Teflon.

8. A machine according claim 1,
characterized in
at least two additional illumination devices (14, 15), by which the monitoring area of the sensor (3, 13) can be illuminated from the side facing the sensor.

9. A machine according to claim 1,
characterized in that
the surface of the counter support (3, 13) facing the material web (4) is embodied convexly in its cross-section.

10. A method for printing material webs (4),
in which the material web (4) is guided through a station (1, 11, 41) for monitoring the printed material web (4),
in which (1, 11, 41) the material web (4) is monitored via a sensor for monitoring the material web (4), while the material web (4) is guided by at least one counter support (2, 12) for guiding the web (4), with at least one counter support being located at the side of the material web (4) facing away from the sensor (3, 13),
and with the surface of the counter support (2, 12) facing the material web (4) being made at least partially from a porous or perforated material, with a fluid flowing through it,
characterized in that
the material web (4) is guided past an optic element (34, 39), such as a reflector and/or a background illumination, while the sensor (3, 13) monitors the material web (4).
